(19) United States
(12) Patent Application Publication
(10) Pub. No.: US 2005/0041286 A1
(43) Pub. Date: Feb. 24, 2005

(54) Front projection screen and systems using same

(76) Inventor: Peter McDuffie White, Dallas, TX (US)

Correspondence Address: SLATER & MATSIL, L.L.P., 17950 PRESTON RD, SUITE 1000, DALLAS, TX, 75252-5793, US

(21) Appl. No.: 10/712,969

(22) Filed: Nov. 13, 2003

Related U.S. Application Data
(60) Provisional application No. 60/496,309, filed on Aug. 18, 2003.
(60) Provisional application No. 60/498,175, filed on Aug. 25, 2003.
(60) Provisional application No. 60/506,440, filed on Sep. 26, 2003.

(51) Int. Cl. G03B 21/60

(52) U.S. Cl. 359/452

(57) ABSTRACT

A front projection screen comprises a transparent substrate and a plurality of opaque reflective regions. The light reflective regions could comprise reflective spheres, indentations in the transparent substrate having a reflective coating on a surface thereof and a non-reflective material filling said indentation, portions of reflective spheres, reflective irregularly shaped particles, a pattern of lines, dots, graphic shapes, or granules, three-dimensional forms, reflective grooves, Fresnel patterns, extensions from the surface of the substrate, or reflective ridges formed on a surface of said transparent substrate. The light reflective regions could be formed from particles selected from the group consisting of a fine gradation of ground rock, crystal, metal filings, sand, powder, or specially produced three dimensional forms. The screen could be used in an image projection system employing a projector and in a communications system employing a projector, camera, and transmission equipment.

This application claims priority benefit to the following U.S. Provisional Patent Applications: Ser. No. 60/496,309, filed Aug. 18, 2003; Ser. No. 60/498,175, filed Aug. 25, 2003; and Ser. No. 60/506,440, filed Sep. 26, 2003. Each of these provisional patent applications is incorporated herein by reference.

### CROSS-REFERENCE TO RELATED APPLICATIONS

This application is related to the following co-pending applications: Ser. No. 10/049,253, filed Feb. 8, 2002 and Ser. No. 10/389,308, filed Mar. 14, 2003. Both of these applications are hereby incorporated herein by reference.

### TECHNICAL FIELD

The invention relates generally to projection screens and display systems and more particularly to an improved front projection screen employing reflective surfaces and systems employing the same.

### BACKGROUND

There is a need for a new type of front projection screen since business computer displays and consumer television screens are increasing in size to meet market demand. However, currently available technology has not delivered larger screen sizes at an affordable price. LCD screens are expensive at the larger sizes up to 30 inches. Plasma screens range from 42 to 61 inches, but these are especially costly. Any large screen display technology that is based on the electronic generation of the illumination of an image within the surface of the screen will be more expensive than a screen that is simply a surface reflecting light from a projector.

Rear projection screens have inherent limitations. Rear projection screens require an enclosure for the projection path, which becomes too large to fit through a single door at the larger sizes. The bulk of the RP televisions and monitors make them undesirably large for most living rooms or standard offices.

Front projection screens have been around as long as the first projectors. However, front projection screen technology has not advanced substantially in the last century. Front projection screens are still primarily white or silver. These light colored, highly reflective screens are not ideal for usage in normal office or home settings, which have sufficient ambient light to create a suitable working or living environment. The problem is that the ambient light reflects off the screen surface in addition to the light of the projected image. Therefore, any portion of the projected image that should appear black is washed out by the reflected ambient light. To address this problem, brighter projectors are being used to increase the brightness of the light portion of the image relative to the light level of the ambient light on the screen. However, the brighter light output of the projector increases the cost and does not result in a high contrast ratio for optimal image quality.

There is a need for a screen that allows ambient light to pass through it while reflecting light from an image projector. Furthermore, there is a need for a screen that is semi-transparent so that images on the screen will appear to float in front of a three dimensional setting that can be viewed through the semi-transparent screen. This true depth relationship of the image on the screen appearing in front of a background is very effective in displaying 3D graphics for illustration, education and advertising. Displaying a life-size person on a semi-transparent screen will produce a perception of the person appearing to be within the three dimensional setting, which can achieve a sense of presence.

Furthermore, there is a need for a front projection screen that is semi-transparent to allow a camera to view through it. There are numerous opportunities for improving communication whereby the user views a projection screen displaying an image while the user can be viewed with a camera within the area of the screen. With a screen that allows the camera to see through the screen at the same time as it displays an image, it is possible to match the location of a camera to the location of the eyes of a person displayed on the screen. Through this alignment of the eye line of the displayed person and the line of sight of the camera., it is possible to simulate eye contact, such as described in co-pending patent application Ser. No. 10/389,308, filed Mar. 14, 2003, which application is incorporated herein by reference.

There is a demand for improved two way distance communication that is more effective than video conferencing, which displays a video image of a person on a flat screen. With a semi-transparent screen, it is possible to view a projected image of a person on a screen while viewing through the semi-transparent screen to see a three dimensional background behind the person. By viewing the transmitted person in the context of the three dimensional setting and having the line of sight for eye contact, it is possible to achieve a greater sense of presence.

A semi-transparent projection screen has further advantages for camera viewing from behind the screen. Since the camera views from behind the screen, it is possible to capture a straight on view of a user looking at the screen. This direct view is ideal for image recognition that can be used for identification of a user for security reasons and for image analysis of the user for the purpose of advanced human computer interface using artificial intelligence to interpret facial expressions, body language and hand gestures.

FIG. 1 shows prior art of a stretched fabric or scrim that forms a screen 5 for projection from the front. Since the screen 5 has an open mesh or pattern of holes, it is possible for the camera 3 to view through the screen. However, the path of light 4 projecting from the projector 2 strikes the lens of the camera 3. Also, the camera will detect the light projected upon the screen surface 5, which will obscure the image of the viewer 1 as it is taken by the camera 3. FIG. 2 shows a front view of the screen 5. Since the screen surface will be light in value for the purpose of displaying the projected light, it will inherently also reflect ambient room light.

FIG. 3 shows prior art of a detail of the thread 7 of the scrim 5 in cross section. Light projected onto the scrim 5 illuminates the threads 7 and therefore directs light 6 toward the viewer. However, FIG. 4 shows that the illuminated threads 7 will also direct some light 8 toward the camera 3, which will obscure a clear view through the screen 5. This undesirable light includes both light 4 from projector 2 (FIG. 1) and also ambient light as well (not shown).

What is needed, therefore, is a front projection screen that improves the image on the screen by minimizing reflection of ambient light. What is also needed is a semi-transparent screen that allows for good image projection while at the same time allowing for creating the illusion of floating graphics or displaying of an image of a person appearing to be within the three dimensional setting of the room.

### SUMMARY OF THE INVENTION

The problems and needs outlined above are addressed by preferred embodiments of the present invention. In accordance, one aspect of the present invention for a front projection screen comprises a transparent substrate and a plurality of opaque reflective regions formed integral to the transparent substrate. The opaque reflective regions may be adhered to the transparent substrate or formed within the transparent substrate. In various embodiments, the reflective regions could comprise one or more of reflective spheres, indentations in the transparent substrate having a reflective coating on a surface thereof and a non-reflective material filling said indentation, portions of reflective spheres, reflective irregularly shaped particles, a pattern of lines, dots, graphic shapes, or granules, three-dimensional forms, reflective grooves, Fresnel patterns, extensions from the surface of the substrate, and reflective ridges formed on a surface of said transparent substrate.

In another aspect, the present invention provides for an image projection system for displaying images with a front projection. The system includes a projector with placement of the projector in front of the screen and offset from the middle of the screen. The screen includes a transparent substrate and a plurality of opaque reflective regions formed integral to the transparent substrate. The reflective regions may be adhered to a surface of the transparent substrate or may be formed within the transparent substrate.

In yet another aspect, the present invention provides for a communications system for allowing a user to communicate with a remote location. The communications system includes a projector in front of the screen and offset from the middle of the screen, and a screen comprising a transparent substrate and a plurality of opaque reflective regions formed integral to the transparent substrate. The communications system further includes a camera positioned behind the semi-transparent screen, a microphone positioned to receive sounds from a viewing area, speakers positioned to project sound transmitted from a remote location to the viewing area, and transmission equipment receiving signals from the remote location and transmitting to the remote location signals received from the camera and microphone.

Various advantages will be apparent to one of skill in the art arising from preferred embodiments of the invention. One such advantage is that since the screen is semi-transparent, it allows the majority of ambient light to pass through the screen instead of being reflected off the screen toward the viewer. As a result, the front projection screen will have the improved image quality of a higher contrast ratio.

In one embodiment of the invention, when the light reflecting elements are indentations in a transparent substrate, there is no part of the reflective surface that would reflect light toward a camera behind the screen. This embodiment has the advantage that the camera could view through the semi-transparent screen without having unwanted light wash out the image.

In another embodiment of the invention, where the light reflecting elements are segments of a sphere, the projected light is preferably reflected substantially equally from each sphere to the full viewing angle. This provides the advantage of a substantially uniform brightness across the screen. Advantageously, a screen comprised of reflective spheres will reflect light directly toward the viewer, even if the angle of projection toward the screen is away from the viewer.

Another advantage of the semi-transparent screen is that it can be used without a black background so that the viewer can see through the screen to a three dimensional setting behind the screen. Bright images projected on the semi-transparent screen will appear at the plane of the screen while areas of the screen that do not have any light projected on it will remain substantially transparent, allowing the viewer to see through to the three dimensional setting behind. Since the viewer sees a true depth relationship between the image of the plane on the screen and the three dimensional setting behind, the image on the screen appears to be three dimensional itself. This creates the illusion that images are three dimensional and are floating in the three dimensional setting, which has the advantage of capturing the attention of viewers. Therefore, the embodiments of the invention incorporating this advantageous feature may be very effective for advertising, promotional displays, educational presentations, marketing applications, demonstrations of 3D objects and many other applications of visual communications.

Another advantage of the semi-transparent screen is that a camera can view through to comprise a communications system. By positioning the camera in the location of the eyes of a person displayed on the screen, the viewer will be looking directly in the camera while looking directly at the image of the person. If the person at the remote location has a similar system, the two people can communicate while making apparent eye contact. This achieves a sense of presence for optimal communication over a distance with apparent eye-to-eye contact.

Yet another advantage of the semi-transparent screen is an embodiment as a communications system that has a life-size image of a person that can appear to be within the three dimensional setting of a room. This can be achieved by capturing the image of the person in the remote location on a black background and at a size in the frame that will fill the screen to be life-size. The viewer will see the image of the remote person at the plane of the screen while the screen area surrounding the person will be primarily transparent since no light will be projected upon it. The person will have the illusion of being three dimensional as he or she will be viewed within the three dimensional setting of the room.

In certain preferred embodiments, the image reflecting material is in the form of a Fresnel lens that focuses the light to a focal point in the zone of the viewing position of the viewer. Since the majority of the light reflecting off the screen is directed toward the viewer, the images will appear exceedingly bright. This has the advantage of achieving a bright image with a relatively low brightness projector. For that reason a projector could be operated at a lower brightness, which would result in a longer lamp life and lower electricity usage. It is possible to develop an image display system or communications system that would use a low output and long life lamp, such as a white light LED light source, while still delivering enough light for a bright image for a single viewer positioned at the zone of convergence of light for a front projection mirrored Fresnel pattern on the semi-transparent screen. With this embodiment, the lamp life could be potentially increased, perhaps to 100,000 hours instead of a typical projection lamp life of 1,000 to 2,000 hours, which would significantly reduce the operational cost of using the projector.

### BRIEF DESCRIPTION OF THE DRAWINGS

The above features of the present invention will be more clearly understood from consideration of the following descriptions in connection with accompanying drawings in which:

FIG. 1 illustrates a prior art configuration for a scrim that has a fine pattern of openings allowing a camera to see through;

FIG. 2 illustrates a front view of the scrim in FIG. 1;

FIG. 3 illustrates a detail of the scrim of FIG. 1 showing light from a projector reflecting off threads of the scrim;

FIG. 4 illustrates projected light illuminating the threads of the scrim allowing light to enter the lens of a camera;

FIG. 5 illustrates a configuration with a projector with an acute angle of projection onto a screen with a fine pattern, which is partially open to allow a camera to see through;

FIG. 6 illustrates a front view of the screen in FIG. 5;

FIG. 7 illustrates a detail of FIG. 5 with a transparent substrate with opaque particles that reflect light toward a viewer;

FIG. 8 illustrates projected light reflecting off the underside surface of fine particles that allows light to be directed toward a camera;

FIG. 9 illustrates a transparent substrate with indentations in the back surface;

FIG. 10 illustrates the back surface of FIG. 9 being covered with a highly reflective material;

FIG. 11 illustrates the indentations of FIG. 10 covered with an opaque material;

FIG. 12 illustrates the back surface of FIG. 11 with the opaque material cleared from the back of the transparent substrate while remaining in the indentations;

FIG. 13 illustrates projected light reflecting off the front of the silvered indentations toward the direction of the viewer;

FIG. 14 illustrates projected light passing through the transparent substrate to a black background without passing into the lens of the camera;

FIG. 15 illustrates an enlarged detail of arrangement of a front view of sections of highly reflective micro spheres packed to form a reflective surface for a projection screen;

FIG. 16 illustrates the lowest angle of projected light toward one micro sphere to determine the lowest point on the surface of the sphere where projected light would be directed toward a viewer;

FIG. 17 illustrates a manufacturing process with a plate with drilled indentations and a mold formed through casting;

FIG. 18 illustrates a screen cast from the mold of FIG. 17 with light from a projector reflected toward a viewer;

FIG. 19 illustrates the screen of FIG. 18 with ambient light reflecting toward the viewer;

FIG. 20 illustrates the highest angle of projection toward a micro sphere to determine the highest point on the surface of the sphere that would reflect light toward the viewer;

FIG. 21 illustrates the portion of the sphere that reflects light toward the viewer;

FIG. 22 illustrates the arrangement of spheres shown in FIG. 15 with the top portion of the sphere removed;

FIG. 23 illustrates the screen with the upper surface of the truncated section of a sphere with ambient light reflecting toward a black background while not entering the lens of the camera;

FIG. 24 illustrates a manufacturing process for drilling a steel plate to produce a pattern of protruding sections of spheres to make a mold;

FIG. 25 illustrates a top view of the mold with the sections around the sections of spheres being cleared;

FIG. 26 illustrates the pattern of sections of spheres on the steel mold;

FIG. 27 illustrates the pattern of sections of spheres with the top portion removed;

FIG. 28 illustrates a front view of a semi-transparent screen making it possible to clearly see objects behind the screen;

FIG. 29 illustrates the screen in FIG. 28 with an image of a person projected upon it which obscures the view of the shroud holding the camera and further illustrates that, where there is no projected image, the view through the screen to an object behind the screen is unobstructed;

FIG. 30 illustrates a configuration of a screen with a reflective surface on a Fresnel lens that is optically designed to reflect the projected image horizontally toward the user;

FIG. 31 illustrates a configuration of a screen with a reflective surface on a Fresnel lens that is optically designed to reflect the projected image to a focal point at the viewing position of the user;

FIG. 32 illustrates a front view of the screen in FIG. 31 showing the off axis pattern of the Fresnel lens and the location of the camera behind;

FIG. 33 illustrates detail of a prior art Fresnel lens with projected light reflecting off the underside ridges to be directed toward the user;

FIG. 34 illustrates detail of a prior art Fresnel lens with undesirable ambient light reflecting toward the user;

FIG. 35 illustrates a preferred embodiment screen with ridges of the Fresnel lens reflecting projected light toward the user;

FIG. 36 illustrates undesirable ambient light passing through the transparent surfaces of the back of the Fresnel lens of FIG. 35;

FIG. 37 illustrates undesirable ambient light reflecting off short ridges toward the transparent back of the Fresnel lens of FIG. 35;

FIG. 38 illustrates undesirable ambient light reflecting off the optical surfaces of the Fresnel lens of FIG. 35, to be directed away from the view of the user;

FIG. 39 illustrates a master form cut with Fresnel grooves;

FIG. 40 illustrates a form molded from the form in FIG. 39;

FIG. 41 illustrates a transparent substrate with Fresnel patterns formed from the master in FIG. 40 with the addition of a highly reflective material to the surface that contains the Fresnel patterned grooves;

FIG. 42 illustrates the Fresnel lens with the patterned surface covered with an opaque material that covers the silvered surface and fills the grooves;

FIG. 43 illustrates the Fresnel lens with the flat portion of the patterned surface cleared of the opaque material and the silvered reflective material to make that portion of the lens transparent;

FIG. 44 illustrates the Fresnel lens laminated to front and back substrates to protect the Fresnel lens and to produce a rigid screen with a black material behind to absorb transmitted light;

FIG. 45 illustrates a front view of a pattern of grooves of a Fresnel pattern with a spacing between the grooves that is adequate to allow for a wave pattern to run along the length of the Fresnel groove;

FIG. 46 illustrates a front view of a Fresnel groove with a wave pattern that reflects incoming light for a wider angle of view;

FIG. 47 illustrates a front view of a Fresnel groove with a wave pattern that is deep enough to achieve a wide spread of light for a maximum angle of view;

FIG. 48 illustrates a preferred configuration system in which the Fresnel lens reflects light projected from the projector toward the user; and

FIG. 49 illustrates the display system of FIG. 48 with the screen and projector stored in a supporting structure.

### DETAILED DESCRIPTION OF THE ILLUSTRATIVE EMBODIMENTS

Referring now to the drawings, wherein like reference numbers are used to designate like elements throughout the various views, several embodiments of the present invention are further described. The figures are not necessarily drawn to scale, and in some instances the drawings have been exaggerated or simplified for illustrative purposes only. One of ordinary skill in the art will appreciate the many possible applications and variations of the present invention based on the following examples of possible embodiments of the present invention.

A first embodiment of the invention of a front projection screen is illustrated in FIG. 5. A data or video projector 2 projects upwards to the screen 11. A baffle 9 is positioned between the camera 3 and the projector 2 so that the line of projection 4 does not strike the lens of the camera. This baffle may be optionally extended above and below the camera as shown by reference numeral 10. While projector 2 can be a conventional projector, in the preferred embodiments projector 2 is designed to project images at a highly acute angle. A projection system has been invented and developed by NEC that uses aspheric mirrors, instead of typical lens optics, to focus the projected light onto the screen. The projection path of their first commercial projector, the WT600, has been used for our illustrations.

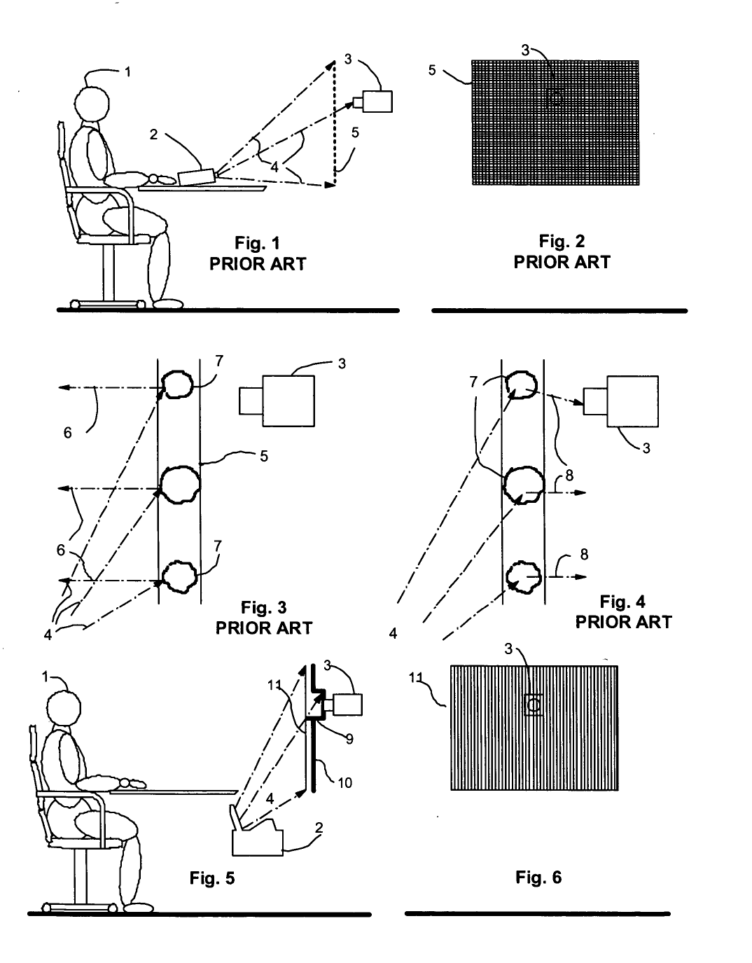

FIG. 6 illustrates a front view of the screen 11 as shown in FIG. 5. The screen 11 is comprised of a transparent substrate, such as glass or clear plastic, with a fine pattern of reflective material. The reflective material is fine enough that the viewer 1 does not see the individual particles or reflective components. The pattern of reflective material is open enough for the camera 3 to see the viewer 1. The reflective material could be a fine gradation of ground rock, metal, or three dimensional forms positioned on or within the transparent substrate to form a projection surface. The reflective material could be a pattern of lines, dots or other designs applied to the substrate so that the surface of the pattern facing the camera 3 is black and the surface facing the viewer 1 is white, silver or in some manner capable of reflecting light toward the user. Unlike the mesh scrim of the prior art, as illustrated in FIGS. 1 through 4, the preferred embodiment screen of the present invention is a matrix (either uniformly or non-uniformly distributed) of reflective regions (particles, ridge surfaces, or the like) in a transparent substrate.

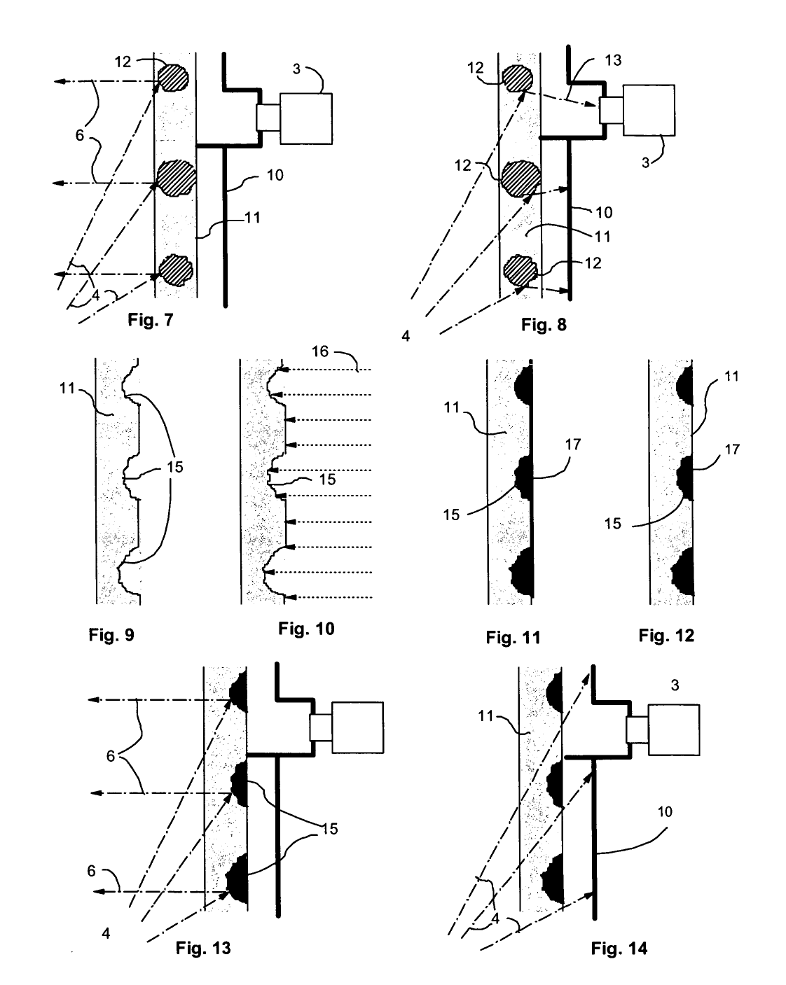

FIG. 7 shows an enlarged detail of opaque particles 12 suspended in a transparent substrate 11 with projected light 4 from projector 2 (FIG. 5) reflecting off the reflective surface of the particles to direct light 6 toward the viewer. As will be described in greater detail below, the opaque particles 12 can be formed on or in the transparent substrate, or alternatively can be formed of reflective surfaces formed on or within the substrate. Note, however, that projected light 4 striking the underside of the particles 12 is reflected into the lens of camera 3, as shown in FIG. 8. This undesirable reflection of light 13 into camera 3 can be minimized, as described in detail below.

The steps of forming a preferred embodiment front projection screen in which opaque, reflective regions are formed within the transparent substrate will now be described with reference to FIGS. 9 through 14. FIG. 9 shows a transparent substrate 11 with indentations 15 that could be made by sandblasting, striking with a laser, drilling or in some other manner causing indentations to be formed in the substrate. FIG. 10 shows reflective material or metalizing 16 being applied to the surface of the substrate 11, including within the indentations 15. The reflective material could be formed of a bright silver reflective paint. Another approach is to use a vacuum metalizing process that is normally used to produce mirrors.

After the reflective material is applied to the back surface of substrate 11, a non-reflective opaque material 17 is applied to the back surface. As illustrated in FIG. 11, this opaque material 17 coats the back surface of the substrate 11 and fills the indentations 15. Non-reflective material 17 is preferably a paint or plastic substance that hardens as it dries or cures. It is important that the opaque substance covers the silvered surface in the indentations 15 so that this silvered surface is not cleared when the back of the substrate is cleaned and buffed to make it transparent. As illustrated in FIG. 12, the opaque material 17 is removed from the back surface of the substrate 11, thus leaving the substrate 11 transparent in those regions surrounding the reflective indentations 15. The opaque material 17 can be removed from the flat back surface by polishing or abrading the back surface (although care must be taken not to introduce scratches or other optical anomalies into the substrate that could cause reflections into the substrate). Alternatively, the opaque material 17 may be removed by a solvent process such as by wiping (e.g, using a squeegee) a suitable solvent across the back surface. In this manner, a semi-transparent substrate is formed. The substrate reflects light that impinges upon the reflective surfaces of indentations 15 and passes light impinging upon the remainder of the substrate. In applications where there is a camera behind the screen it may be advantageous to have the opaque material 17 comprised of a black substance or to be coated black in a finishing process so that there is no visible light reflected off this back surface toward the camera.

FIG. 13 shows light 4 from the projector 2 reflecting off the reflective front surface of the indentations 15 so that the reflected light 6 is directed toward the viewer.

As further illustrated in FIG. 14, light 4 from the projector 2 that does not impinge upon one of the reflective regions passes through the transparent substrate 11 to the black background or shroud 10 instead of being reflected toward the camera 3. Note that, in contrast to FIG. 7 where an entire opaque particle is embedded in the substrate, only the optically “necessary” portions of the reflective region are used in the embodiment shown in FIGS. 13 and 14. By optically necessary, it is meant that only sufficient reflective surface to reflect light from the projector to the viewer is employed. Light that would otherwise impinge upon other portions of the reflective regions and reflect into the camera lens (such as illustrated in FIG. 8) now passes harmlessly through the transparent substrate 11 and onto shroud 10, as shown in FIG. 14.

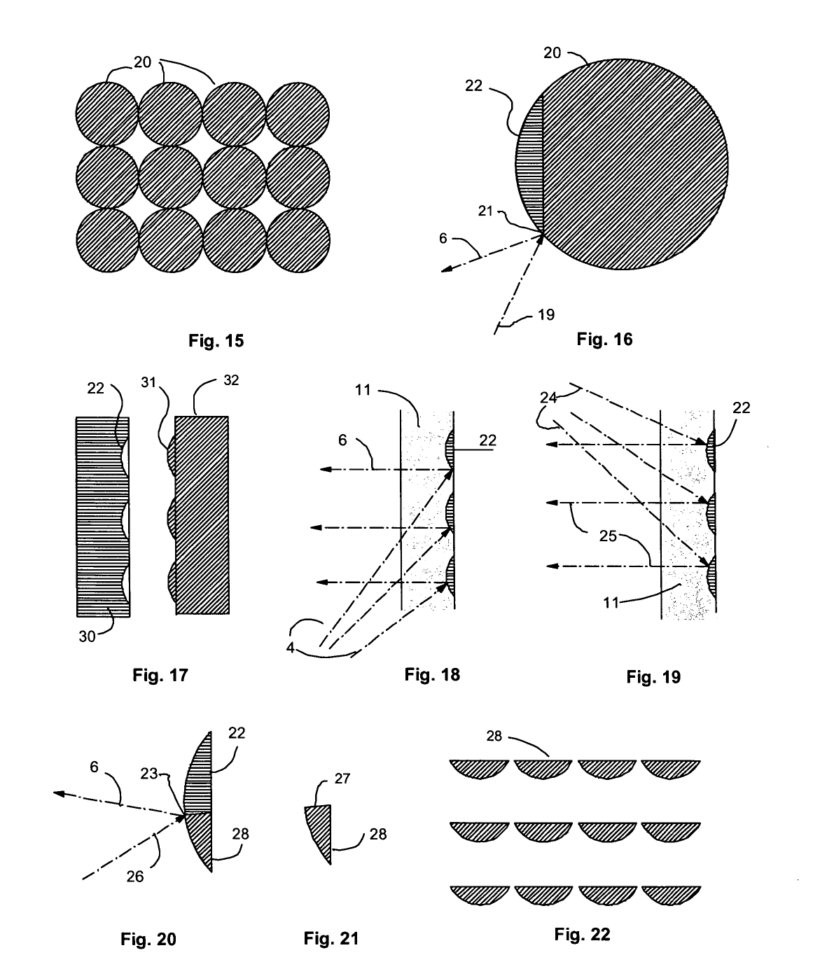

In other embodiments of a semi-transparent screen, the reflective regions can be formed of reflective spheres. FIG. 15 shows a tight formation of highly reflective spheres 20 as seen from the front of the screen. FIG. 16 illustrates that only a portion of each individual reflective sphere 20 actually reflects light from the projector toward the viewer. As show in FIG. 16, there is a line of projection of light 19 from a projector that is the most acute angle of projected light upwards toward the screen. This angle of projection could vary depending on the projector. For the purpose of illustration, the angle of projection could be 64 degrees upwards from a horizontal plane. The direction of light 6 reflected off the sphere toward the user indicates an angle that would be sufficiently in a downwards direction to reach the lowest anticipated position of a viewer. For illustration, this angle could be 20 degrees downward from a horizontal plane. The point of intersection on the sphere for projected light 19 for reflected light 6 to be in the direction of the lowest position of a viewer is marked on the sphere 20 by point 21. By this analysis of the projection angle and reflection angle it is determined that from the left of point 21, light will be reflected toward the viewer while light striking the surface of the sphere to the right of the point 21 will not be reflected toward the viewer. Therefore, the portion of the sphere on the right of the point 21 is not needed for the purpose of reflecting light toward the viewer. The segment of the sphere that is on the left of point 21 is indicated by the area 22. By way of illustration, if the sphere was 31.25/1000th of an inch in diameter, the segment of the sphere shown at point 21 vertically upwards would be 21/1000th of an inch in diameter.

FIG. 17 shows a plate 30 that has indentations 22 that form the portions of the spheres that reflect light toward a viewer as illustrated in FIG. 16. These indentations 22 could be drilled into the plate 30 with a drill bit with a round head. With the use of a drilling machine with computer numeric control it is possible to accurately produce a pattern of indentations 22. By way of illustration, a drill bit with a 31.25/1000th diameter would drill a hole to a depth of 4/1000th to produce a hole 21/1000th in diameter. A casting 32 of plate 30 will produce protrusions 31, which can be used as a mold for the casting of a screen with indentations as illustrated in FIG. 18. The screen in FIG. 18 has the same process of surfacing the indentations 22 with reflective material and then filling with opaque material as has been described in FIGS. 10 through 12. In FIG. 18 light 4 from a projector reflects off the reflective indentations 22 in the direction of light 6 toward the viewer. In FIG. 19 ambient light 24 reflects off the reflective indentations in the direction 25 of the user, which is the undesirable effect of allowing ambient light to wash out the image on the screen.

FIG. 20 shows the most direct angle of light 26 that would be projected from the projector toward the reflective surface of the sphere 22. For illustration the angle of projection could be 32 degrees from a horizontal plane. The direction of light 6 toward the viewer is in the most upward direction that is needed to reach the highest viewing position. This angle of the light 6 could be an upwards angle of 20 degrees from a horizontal plane. The point 23 indicates the point of reflection. Above point 23, light does not reflect toward the selected viewing positions, but rather is reflected in a direction that is higher than the viewing position. Therefore, there is no need for a reflective surface above the point 23. For illustration this point 23 could be 2/1000th lower than the center of the segment of the sphere. The area 28 is the remaining portion that is needed for reflecting light toward the viewing position. This portion for illustrative purposes could be the lower 8.5/1000th of the total 21/1000th of an inch in height of the segment of the sphere. FIG. 21 shows only the portion 28 that is necessary for satisfactory reflection of light from the projector.

FIG. 22 shows an arrangement of sphere sections as illustrated in FIG. 15 with the upper portions of the sphere sections removed leaving the lower portion of the sphere sections 28. This upper portion can be removed by using a milling machine to mill the mold 32 illustrated in FIG. 17 to remove the top portion of the protrusions 31. Due to the alignment of the sphere sections in horizontal rows, it is possible to run the milling machine in rows to remove the upper sections. For illustrative purposes segments of spheres based on 21/1000th of an inch could be spaced on center for every 22/1000th of an inch. With this spacing there would be approximately 45 rows of segments of spheres for every inch, which would result in a total of 2,480,000 segments of spheres for a screen 30″×40″. This would be a preferred minimum of segments for a screen of this size considering that a projected image of an XGA resolution would have approximately 25 lines per inch. It is important that there are more reflective segments of spheres than the number of projected pixels per inch so that a moray pattern is not generated by the dark spaces between the pixels of the projected image. In this illustration of segments of 21/1000th diameter spheres with a 22/1000th spacing, 27% of the surface is covered by the segments of spheres and consequently 73% of the screen surface is transparent.

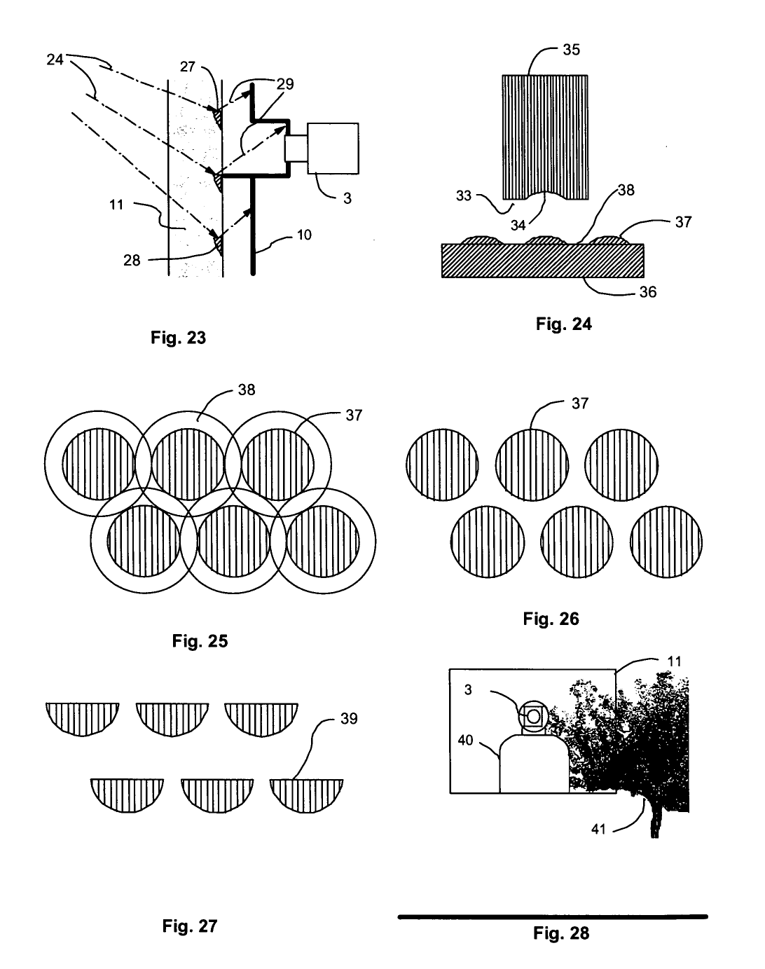

FIG. 23 illustrates a preferred embodiment screen 11 in which only the optically necessary regions 28 are embedded in the transparent substrate. Note that the undesirable ambient light 24 striking the top surface 27 of the reflection area 28 is reflected to the black background 10 and away from the camera 3, as shown by reflected light 29. A further advantage of the screen illustrated in FIG. 23 is that by reducing the surface area of the reflective particles, more light can pass through screen 11, thus allowing for enhanced viewing through the screen with a camera 3.

FIGS. 24 through 27 illustrate a method for manufacturing a screen employing optically important portions of reflective spheres. In order to manufacture large quantities of screens it is preferred to have a mold or patterned stamping form that is made of steel. With a steel master form it would be possible to have a steel roller that would imprint a pattern of segments of spheres as a transparent substrate material was extruded to form patterned sheets. However, it is difficult to cast steel into a mold with fine detail, such as the sections of small spheres. Therefore, it is desirable to machine a pattern into a steel plate. In FIG. 24 a specially designed drill bit 35 has a flat portion 33 and a curved central portion 34. For the purposes of illustration, the drill bit 35 could be 25/1000th of an inch in diameter with a flat portion 33 that was 4/1000th wide and a curved central portion 34 that was 17/1000th wide. The drill bit 35 is drilled deep enough into the steel plate 36 to form a section of a sphere 37 with the curved portion 34 of the drill bit 35. The flat portion 33 is used to form a lower flat surface 38 surrounding the sections of spheres 37. This is further illustrated in FIG. 25 with a top view showing the sections of spheres 37 and the surrounding flat portions 38 that have been cleared by the flat portion of the drill bit. For illustrative purposes, the spacing between the sections of spheres could be 21/1000th of an inch. The completed steel surface is shown in FIG. 26 with the sections of spheres 37. In the final illustration of the manufacturing process, FIG. 27 shows the remaining sections of the spheres 39 after the top portions have been cleared. For purposes of illustration the 17/1000th diameter with a horizontal spacing of 21/1000th will result in 3,150,000 sections of spheres in a 30″×40″ screen. In this illustration 23% of the surface area is covered by the segments of spheres leaving the remaining 77% of the substrate transparent.

Turning now to FIG. 28, a preferred embodiment semi-transparent screen 11 is shown with a camera 3 held in a shroud 40 that is a dark form which could be similar to the silhouette of a seated person. Since the screen 11 is semi-transparent, it is possible to see an object 41 in the three dimensional setting behind the screen. While the present invention is not limited to a communication system employing a camera, one skilled in the art will recognize the advantages provided by a communication system employing preferred embodiments of the present invention. The ability to view a projected image in the context of the three dimensional setting behind the semi transparent screen is one such advantage. The ability for the camera to see through the screen for virtual eye contact between the users of the communication system is another such advantage, as described in further detail below.

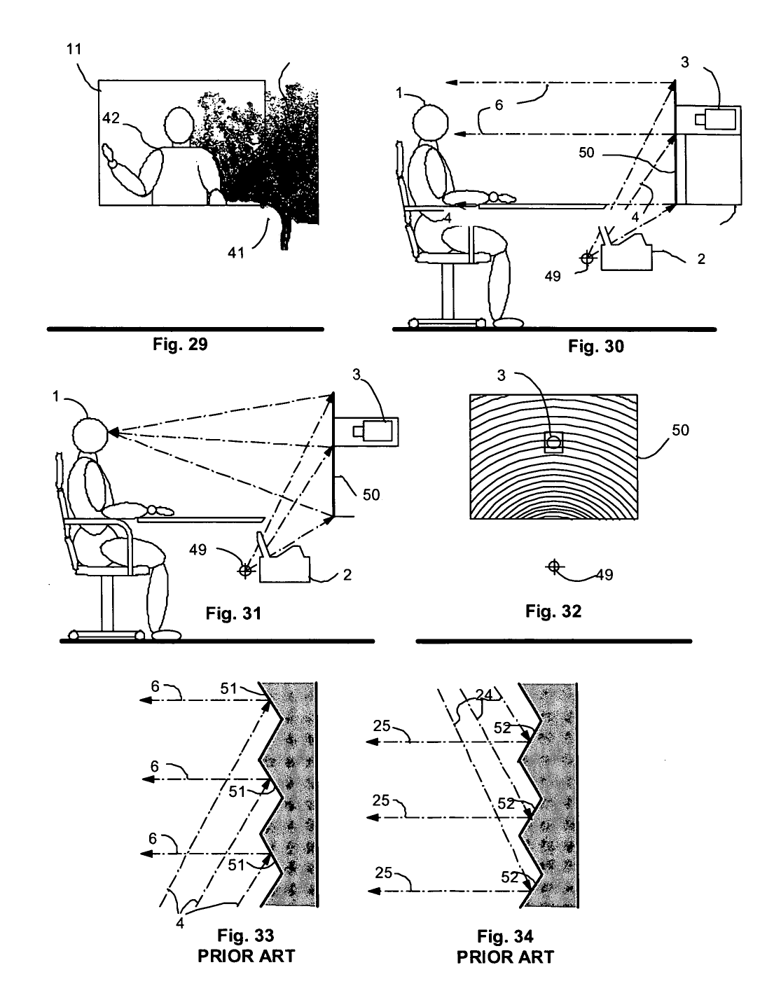

FIG. 29 shows the screen 11 with a projected person 42 appearing as a result of the projected light reflecting off the fine pattern of light material on the screen 11. The shroud 40 with the camera 3 is not clearly visible since they are dark and the bright image of the projected person 42 appears in front. Since the image of the projected person 42 is aligned for the eyes of the person to be at the same height as the location of the camera 3, the viewer appears to be making eye contact by looking at the eyes of the person 42 and consequently looking directly toward the camera 3. If the person 42 at the location of the origination of the image is using a similar configuration, the two people will appear to be communicating while making eye contact. The object 41 appears through the semi-transparent screen 11 when the image of the person 42 has been shot on a black background. Since the background in the image of the person is black, there is no light being projected upon the surface area around the person. As a result, there is no light being projected upon the light patterned surface facing the user, which allows the user to more clearly see through the semi-transparent screen in the area behind. The user can see the depth relationship between the image of the person 42 on the screen 11 and the object 41 that is further behind. In this way the user sees the live image of the person 42 appearing to be within a three dimensional setting. This depth relationship can be seen with any graphic or photographic images that have a black background to allow the user to see the depth relationship to the object 41 behind the screen 11.

FIG. 30 illustrates a projector 2 projecting upon a Fresnel screen 50 that has been surfaced with a reflective material. In this illustration, the optical design of the Fresnel lens has directed the light 6 toward the viewer 1 as parallel light. While this parallel light may be effective for viewing from a distance, the viewer 1 seated at a desk or table close to the screen may not receive an evenly illuminated image from the screen 50 and may see what is commonly called a “hotspot”.

FIG. 31 illustrates a system employing a Fresnel screen 50 that is optically designed to reflect light toward the viewing zone of the viewer 1. This has the advantage of concentrating the light of the projector 2 toward the viewing zone of the viewer 1. As a result, it would be possible to deliver an evenly illuminated bright image to the viewer 1 with a fraction of the typical light output of a projector 2. Note that conventional projection systems require bright light sources for projector 2 in order to effectively illuminate the screen. However, with the use of a focusing Fresnel screen 50 such as illustrated in FIG. 31, it is possible to deliver an adequate amount of light into the user's eyes with a minimal usage of power.

FIG. 32 shows a front view of the screen 50 illustrated in FIG. 31. The Fresnel pattern on the screen 50 is centered from the origination point 49 of the projector 2 in order to reflect the projected image to the user. The manner in which a conventional Fresnel lens can be modified in order to minimize the reflection of ambient light (and hence to improve image quality and allow a lower power light source to be employed) is provided with reference to FIGS. 33 through 36.

FIG. 33 is a close-up detail of a prior art Fresnel screen with projected light 4 from the projector striking the reflective surface 51 of the Fresnel that has been designed to reflect light 6 toward the user. As illustrated in FIG. 34, undesirable ambient light 24 striking the opposite side of the groove 52 of the Fresnel lens is also reflected toward the user as reflected light 25. This reflected ambient light will obscure the view of the user and therefore the image will appear to be “washed out” by the unwanted light.

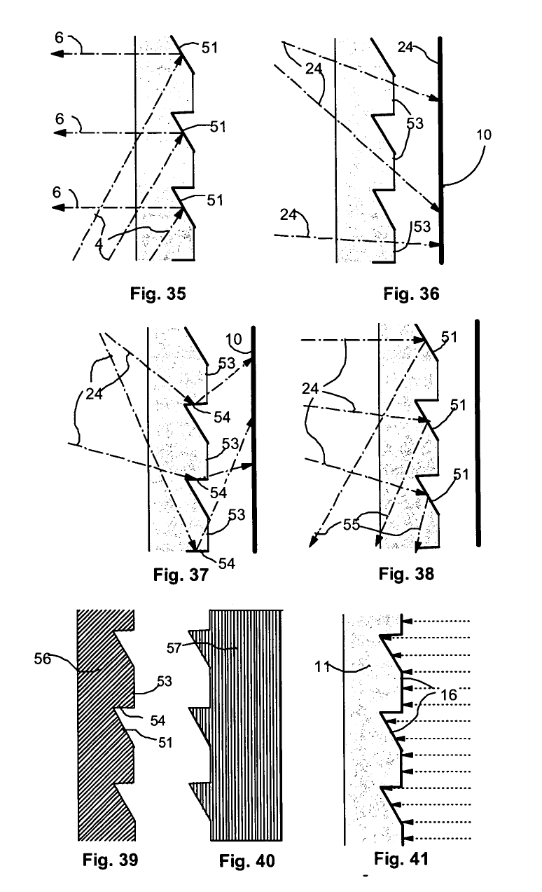

FIG. 35 illustrates an embodiment of the invention, shown in a close-up detail, of a Fresnel lens pattern where the reflective surface 51 reflects light 4 from the projector so that the light 6 is directed toward the viewing zone of the user. As shown in FIG. 36, extraneous ambient light 24 passes through the transparent substrate of the Fresnel lens and exits the Fresnel lens through the clear surface 53 where it is absorbed by a matt black material 10 behind the Fresnel lens. This is because the typical cross-section profile of the ridges has been modified to remove the reflecting surface 52 (FIGS. 33 and 34), so that ambient light is not reflected. In the illustrated embodiment, the pitch of the ridges is preferably around 100 lines per inch. One skilled in the art will recognize, however, that various pitches and configurations can be selected as a result of routine experimentation.

FIG. 37 shows the detail of FIG. 35 with ambient light 24 striking the short ridge 54 of the Fresnel lens and reflecting toward the transparent back surface 53 so that it passes through the Fresnel lens to be absorbed by the black background 10. FIG. 38 illustrates the detail of FIG. 35 with ambient light 24 striking the reflective optical surface 51 of the Fresnel lens so that the reflected light 55 is directed away from the viewing zone of the user. By changing the cross-sectional profile of the ridges of the Fresnel lens, the reflection of ambient light is minimized.

FIGS. 39 through 44 provide an illustrative method for manufacturing a semi-transparent screen with a Fresnel lens, such as illustrated in FIG. 31. FIG. 39 shows a solid material 56, such as brass, steel, quartz, ceramic, or other appropriately hard and machinable material, that has the Fresnel pattern cut into it to form a master. The short surface 54 returning from the Fresnel pattern groove 51 to the flat back surface 53 is close to horizontal so that it is not angled toward the viewer, which could result in the reflection of light toward the viewer. However, the surface 54 is preferably formed at a slight angle, such as 2 or 3 degrees, so that the casting on the master can be easily removed.

FIG. 40 shows a form 57 that has been cast from the master 56 shown in FIG. 39. This form 57 will be of a master for the casting of the Fresnel patterned screens. Form 57 can the same material as 56 or can be another material having sufficient hardness, robustness, and the like to serve the intended purpose.

FIG. 41 illustrates the transparent substrate 11 of the casting from FIG. 40, which will become the optical component with the Fresnel lens that is used to produce the screen. One skilled in the art will recognize that there are numerous ways in which the transparent substrate 11 could be formed from the master illustrated in FIG. 40. The simplest manner would be to heat substrate 11 until it is malleable and then to impress the master illustrated in FIG. 40 onto the surface of substrate 11 in which the indentations 15 are desired to be formed. This substrate 11 is covered with a reflective material 16. This could be light colored or silvered paint being sprayed onto the surface or it could be surfaced with a process of vacuum metalizing.

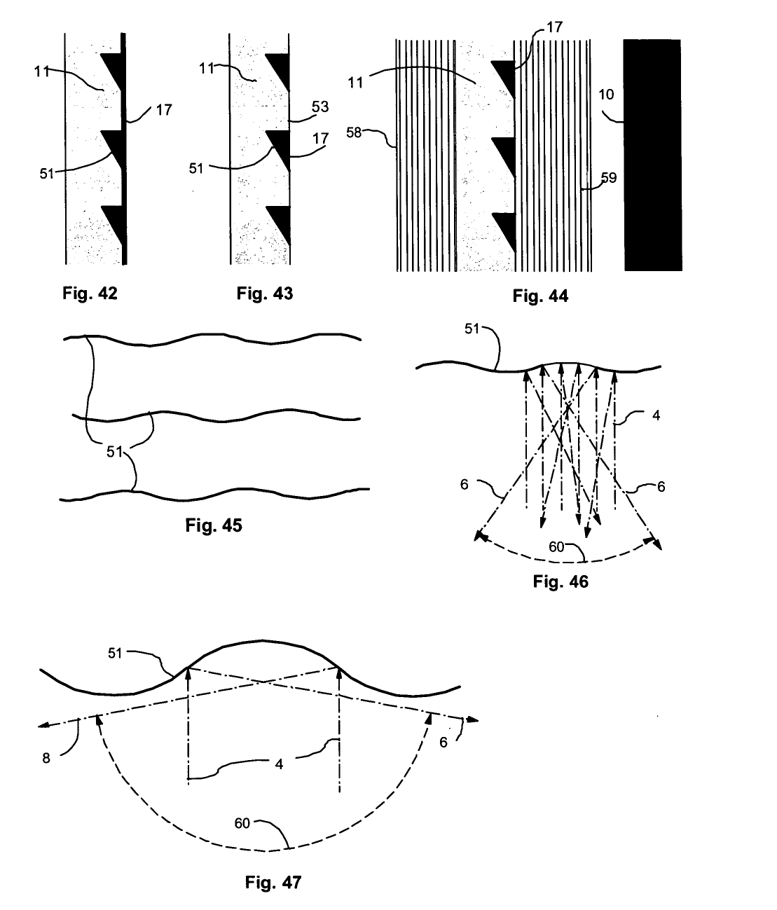

FIG. 42 shows the substrate 11 covered with an opaque material 17, as described above, which is applied over the reflective material 51 surface. This opaque material 17 preferably fills the grooves of the Fresnel pattern. As shown in FIG. 43, opaque material 17 and reflective coating 16 is removed from the flat surface of the substrate 11 to allow light to pass through the transparent surface 53. The reflective coating remains on the optical surface 51 of the Fresnel lens to reflect light toward the viewing zone.

FIG. 44 shows a protective transparent substrate 58 laminated to the front of the substrate 11 of the Fresnel lens. This protective transparent substrate 58 could be comprised of glass, plastic or another transparent material. The substrate 58 could have an antireflective coating (not shown) to minimize unwanted reflections of light from within the room and to minimize the reflection of the projected light from the projector. The substrate 58 should not be thicker than necessary, since light from the projector will enter the substrate and will then be reflected back through the substrate toward the viewer. It would be possible to specify glass that is optimized for the transmission of light without coloration, such as “white” glass. On the back of the Fresnel lens another substrate 59 could be laminated to protect the Fresnel surface in substrate 11 and the opaque material 17 in the grooves of the Fresnel pattern. This substrate 59 could also be glass or plastic with or without an antireflective coating. As a laminated panel the screen could be strong and protected from damage during cleaning or shipping. A black background 10 could be positioned behind the screen to absorb light passing through the screen. By having this black background 10 as a separate surface from the back of the screen, it can be a matt surface and therefore not reflect light back toward the user, which would happen if it was physically the back surface of the substrate 59. This black background 10 could be removed from the line of sight when the user wants to see through the semi-transparent screen to the three dimensional background behind it.

FIG. 45 illustrates a front view of a portion of the Fresnel pattern showing that an adequate amount of space between the reflective ridges 51 has been left to allow for a large percentage of the screen to be transparent. The amount of transparency can be adjusted for the applications of the screen, but a semi-transparent screen could work effectively for viewing through the screen to a three dimensional background setting with a 50 to 90 percent transparent surface. Preferably, about a 70 percent transparency design is employed. This illustration shows a modulation or wave pattern of the Fresnel pattern running along the length of the groove.

FIG. 46 illustrates projected light 4 from the projector striking the wavy pattern of a Fresnel groove 51 so that the reflection has a horizontal spread shown as the arc 60. The Fresnel groove will need to be cut with varying angle or pitch along the wave pattern so that the projected light 4 will be reflected in the direction of a horizontal spread 60. In order to achieve an even spread of light in a horizontal direction 60, the angles or pitch will be different across the arc of the Fresnel groove since the angle of light from the projector 4 is different at different locations of the screen. These angles can be calculated by a computer and the Fresnel grooves can be cut by a computer controlled cutting system to achieve the required angles for the wavy pattern of the Fresnel grooves.

FIG. 47 shows the projected light 4 striking a wavy pattern of a groove 51, which is a deep enough wave pattern to direct the reflected light to a very wide angle 60 in a horizontal direction for viewing of the image on the screen from all sides.

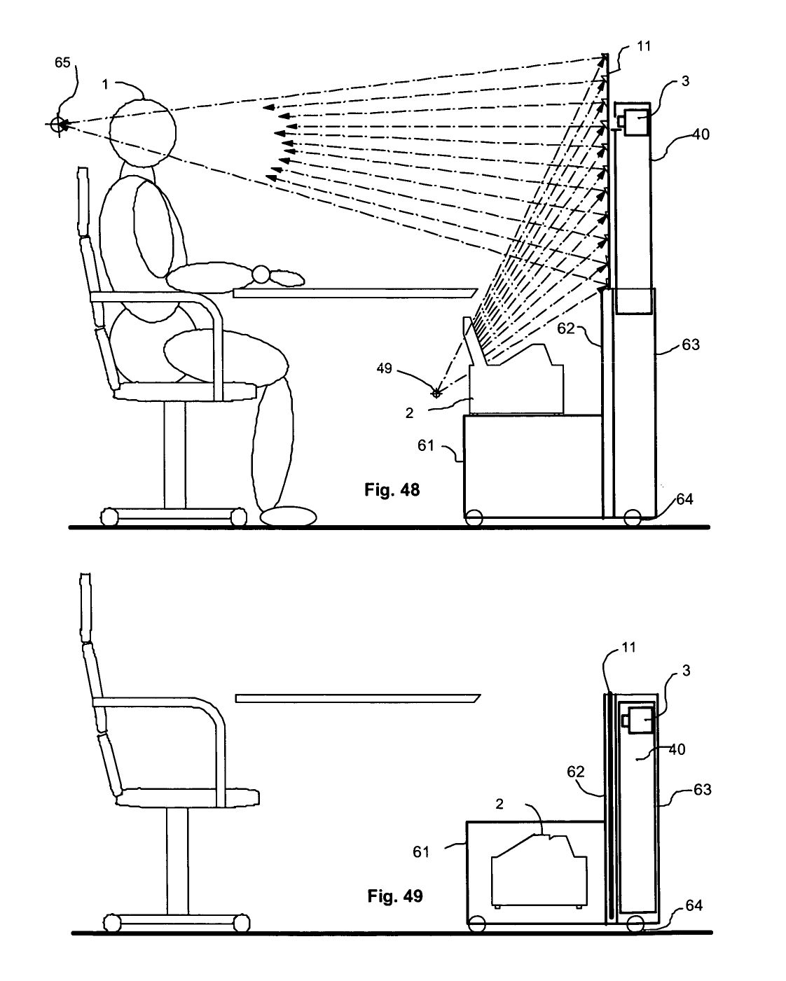

FIG. 48 shows light projecting from the projector 2, which has an optical path point of origination shown at location 49. The light strikes the optical edges of the Fresnel pattern to reflect toward the viewer 1 at a point of convergence 65. The location of the convergence 65 could be behind the user 1 so that there is a wider area of coverage to allow for some movement of the user 1 while still retaining a relatively even illumination of the screen image. Even though most Fresnel lenses are designed to optically direct light from the origination point of a light source to parallel light, it is possible to calculate the optical requirements to reflect light to a point of convergence 65. The projector 2 could be placed on a supporting structure 61. A camera 3 is held in position by a shroud 40 that is located behind the screen 11. The shroud 40 with the camera 3 could by held by a supporting structure 63. The screen 11 is held in position with a supporting structure 62. The supporting structures for the display system could be on casters 64. As described above, the camera 3 is an optional feature of the preferred embodiment, in which the system is used as a communication device. Under such an application, appropriate devices, such as speakers, a microphone, and telecommunications equipment will also preferably be employed and contained within the housing of the overall system. In other applications, however, the projector 2 and screen 11 can be employed simply as a display device, without the need for camera 3 and its associated audio and communications equipment.

FIG. 49 illustrates a preferred embodiment display system that can be compactly folded and stored when it is not in use. The projector 2 is placed in the supporting structure 61. The screen 11 is lowered into the supporting structure 62. The shroud 40 and camera 3 are lowered into the supporting structure 63. The enclosed display system is on casters 64 for easy movement. Elements 61, 62, and 63 are preferably integrated into a single supporting structure.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. For instance, in the above described embodiments, it is assumed that most ambient light comes from above the projection screen and that the projector will be placed below the screen. The teachings of the present invention are not so limited, however, and one skilled in the art will readily recognize that the reflecting surfaces of the above-described semi-transparent screens can readily be adapted for use in a room or environment wherein ambient light comes primarily from the side or some other orientation relative to the screen. Likewise, the projector could be placed above or to the side of the screen. Thus, it is intended that the following claims be interpreted to embrace all such further modifications, changes, rearrangements, substitutions, alternatives, design choices, and embodiments.

1. A front projection screen comprising:
a transparent substrate; and
a plurality of opaque reflective regions formed integral to the transparent substrate.

2. The front projection screen of claim 1 wherein the opaque reflective regions are randomly distributed on said transparent substrate.

3. The front projection screen of claim 1 wherein a matrix of opaque reflective regions are adhered to a surface of the transparent substrate.

4. The front projection screen of claim 1 wherein a matrix of opaque reflective regions are formed within the substrate.

5. The front projection screen of claim 1 further comprising at least one additional transparent substrate adjacent said transparent substrate.

6. The front projection screen of claim 1 further comprising a non-reflective surface adjacent said transparent substrate.

7. The front projection screen of claim 1 wherein said plurality of opaque reflective regions are formed from an element selected from the group consisting of reflective spheres, indentations in the transparent substrate having a reflective coating on a surface thereof and a non-reflective material filling said indentation, portions of reflective spheres, reflective irregularly shaped particles, a pattern of lines, dots, graphic shapes, or granules, three-dimensional forms, reflective grooves, Fresnel patterns, extensions from the surface of the substrate, and reflective ridges formed on a surface of said transparent substrate.

8. The front projection screen of claim 1, wherein the opaque reflective regions are formed from particles selected from the group consisting of a fine gradation of ground rock, crystal, metal filings, sand, powder, and specially produced three dimensional forms.

9. The front projection screen of claim 1, wherein the reflective regions have a back surface that is substantially black and a front surface that is substantially reflective.

10. The front projection screen of claim 1, wherein the substrate includes a flat surface containing a pattern of indentations, each indentation having an inner surface covered with a reflective coating and each indentation being filled with an opaque material.

11. The front projection screen of claim 1, wherein the opaque reflective regions comprise an array of micro sphere sections incorporated into the screen, each micro sphere section being a pre-determined section of a micro sphere that reflects light from a projector toward the direction of a viewer.

12. The front projection screen of claim 1, wherein the opaque reflective regions are in the pattern of a Fresnel lens, which is comprised of grooves of alternating rows of reflective ridges and transparent rows.

13. The front projection screen of claim 1, wherein the grooves of the Fresnel lens have a modulated pattern along their long axis.

14. The front projection screen of claim 1, wherein the opaque reflective regions comprise less than about 50% of the transparent substrate area.

15. The front projection screen of claim 1, wherein a light absorbing black background is positioned behind the transparent substrate.

16. The front projection screen of claim 1, wherein an image projected on the front projection screen is viewed in the context of a three dimensional setting that can be seen through the screen.

17. An image projection system for displaying images with a front projection, comprising:
a screen comprising a transparent substrate and a plurality of opaque reflective regions formed integral to the transparent substrate; and
a projector with placement of the projector in front of the screen and offset from the middle of the screen.

18. The image projection system of claim 17, wherein the projector has an acute angle of projection to the screen.

19. The image projection system of claim 17 wherein the system has a supporting structure housing the projector when the projector is not in use and storing the screen when the screen is lowered into the supporting structure when the screen is not in use.

20. A communications system for allowing a user to communicate with a remote location, the communications system comprising:
a screen comprising a transparent substrate and a plurality of opaque reflective regions formed integral to the transparent substrate;
a projector with placement of the projector in front of the screen and offset from the middle of the screen;
a camera positioned behind the screen;
a microphone positioned to receive sounds from a viewing area;
speakers positioned to project sound transmitted from a remote location to the viewing area; and
transmission equipment receiving signals from the remote location and transmitting to the remote location signals received from the camera and microphone.

21. The communications system of claim 20 further comprising a black background behind the screen having an aperture to allow the camera to view a user.

22. The communications system of claim 20, wherein the camera is positioned to substantially coincide with an image of a person projected on the screen at eye height of the projected image.

23. The communications system of claim 20 wherein the system has a supporting structure housing the projector when the projector is not in use, storing the screen when the screen is lowered into the supporting structure, and housing the camera when the camera is not in use.
